(19) United States
(12) Patent Application Publication
(10) Pub. No.: US 2020/0398606 A1
(43) Pub. Date: Dec. 24, 2020

(54) CHALK HOLDING APPARATUS

(71) Applicant: Abel Ocampo, La Punte, CA (US)

(72) Inventor: Abel Ocampo, La Punte, CA (US)

(21) Appl. No.: 16/444,338

(22) Filed: Jun. 18, 2019

(51) Int. Cl. B43K 23/016

(52) U.S. Cl. CPC B43K 23/016

(57) ABSTRACT

A chalk holding device may include an elongate shaft having a first end, a second end, and a bulging center portion that slightly curves away from a longitudinal axis of the elongated shaft. It is noted that the bulging center portion is configured to provide a comfortable holding portion for the user, so it is easier for the user to hold the apparatus. The chalk holding apparatus further includes a tightening ring at each of the first end and second end, which is configured to threadedly engage with the first end and the second end to secure the chalk at each end. It is noted that it is easy for the user to replace the chalk when needed. The user can simply untighten the tightening ring, replace the chalk, and secure the new chalk with the tightening ring again.

### FIELD OF THE INVENTION

The present invention relates to a chalk holding apparatus, and more particularly to a chalk holding apparatus that has two ends to hold chalks, and has a bulging center portion so it is easier for the user to hold.

### BACKGROUND OF THE INVENTION

Various types of chalk holding devices have been disclosed in the prior art. Some are designed for use in a conventional manner by grasping the device in one hand held close to the writing surface. Examples include U.S. Pat. Nos. 2,205,907; 5,048,989; 4,468,146; 2,181,202; 5,779,381; 3,603,693; 332,157; and 354,311. U.S. Pat. No. 389,517 discloses a hand-held apparatus that holds three pieces of chalk parallel to one another for drawing lines in triplicate. Other specialized chalk holding devices are disclosed for use in marking livestock as disclosed in U.S. Pat. No. 332,157.

While these devices fulfill their respective, particular objectives and requirements, the aforementioned patents do not disclose a new chalk holding device. The inventive device includes an elongate shaft having a first end and second end to secure two different chalks. Furthermore, the center portion of the elongated shaft is bulging and slightly curves away from the longitudinal axis of the elongated shaft so it is easier for the user to hold the shaft. Also, the chalk holding device includes a tightening ring at each end to secure the chalk. The user can simply untighten the tightening ring to replace the chalk can when needed.

### SUMMARY OF THE INVENTION

It is an object of the present invention to provide a chalk holding apparatus to hold chalks at both ends and the user can choose which end to use when needed.

It is another object of the present invention to provide a chalk holding apparatus with a bulging center portion so it is easier for the user to hold the apparatus.

In one aspect, a chalk holding device may include an elongate shaft having a first end, a second end and a bulging center portion that slightly curves away from a longitudinal axis of the elongated shaft. It is noted that the bulging center portion is configured to provide a comfortable holding portion for the user, so it is easier for the user to hold the apparatus.

Furthermore, a plurality of slits are formed on an outer surface of the elongated shaft to increase the comfortability for the user to hold the apparatus. Preferably, the length of the elongated shaft has is about 3-10 inches. Ideally, the length the elongated shaft is about 5 inches.

The chalk holding apparatus further includes a tightening ring at each of the first end and second end. In one embodiment, the tightening ring is configured to threadedly engage with the first end and the second end to secure the chalk at each end. It is noted that it is easy for the user to replace the chalk when needed. The user can simply untighten the tightening ring, replace the chalk, and secure the new chalk with the tightening ring again.

The chalk holding apparatus may further include a holding string disposed at a center portion of the shaft. In one embodiment, the holding string forms a string ring to enable the user's hand to go through so the user can hold the apparatus while the string ring is located at the user's wrist, so the apparatus will not fall off. Furthermore, when the apparatus is secured at the user's wrist, it is easy for the user to switch from the chalk at the first end to the second end, and vice versa.

### BRIEF DESCRIPTION OF THE DRAWINGS

FIG. 1 is a schematic view of the chalk holding apparatus in the present invention.

FIG. 2 illustrates a schematic view of the tightening ring of the chalk holding apparatus in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

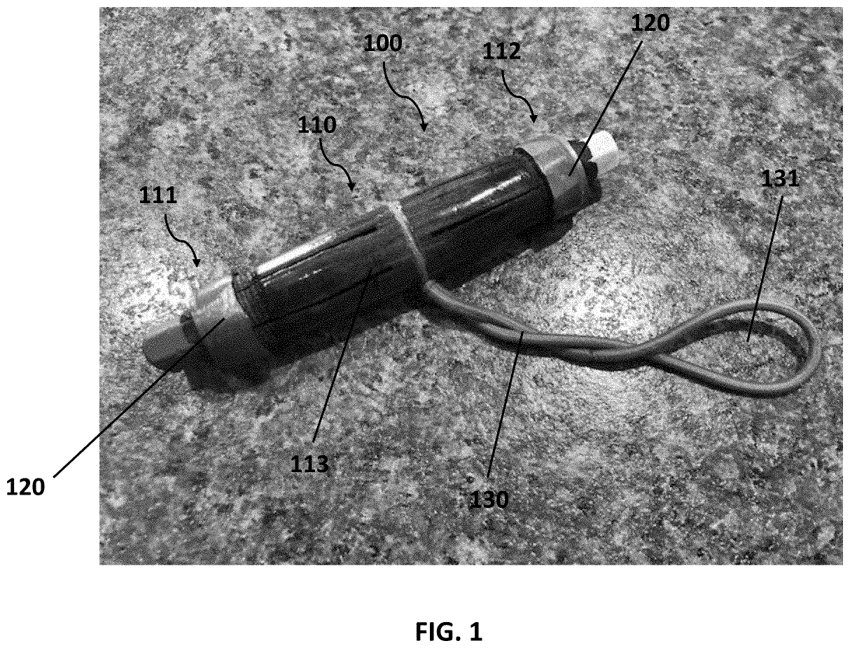

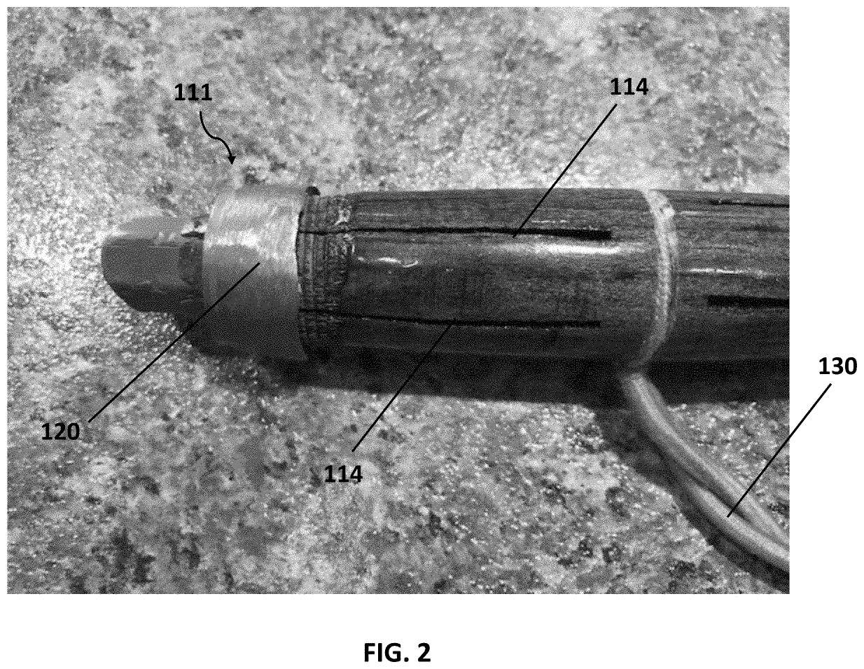

As best illustrated in FIGS. 1 through 2, in one aspect, a chalk holding apparatus 100 may include an elongate shaft 110 having a first end 111, a second end 112 and a bulging center portion 113 that slightly curves away from a longitudinal axis of the elongated shaft 110. It is noted that the bulging center portion is configured to provide a comfortable holding portion for the user, so it is easier for the user to hold the apparatus 100.

Furthermore, a plurality of slits 114 are formed on an outer surface of the elongated shaft 110 to increase the comfortability for the user to hold the apparatus 100. Preferably, the length of the elongated shaft 110 has is about 3-10 inches. Ideally, the length the elongated shaft 110 is about 5 inches.

The chalk holding apparatus 100 further includes a tightening ring 120 at each of the first end 111 and second end 112. As shown in FIG. 2, the tightening ring 120 is configured to threadedly engage with the first end 111 and the second end 112 to secure the chalk at each end. It is noted that it is easy for the user to replace the chalk when needed. The user can simply untighten the tightening ring 120, replace the chalk, and secure the new chalk with the tightening ring 120 again.

The chalk holding apparatus may further include a holding string 130 disposed at a center portion of the shaft 110. In one embodiment, the holding string 130 forms a string ring 131 to enable the user's hand to go through so the user can hold the apparatus 100 while the string ring 131 is located at the user's wrist, so the apparatus 100 will not fall off. Furthermore, when the apparatus 100 is secured at the user's wrist, it is easy for the user to switch from the chalk at the first end 111 to the second end 112, and vice versa.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A chalk holding apparatus comprising:
an elongate shaft having a first end, a second end and a bulging center portion that slightly curves away from a longitudinal axis of the elongated shaft;
a tightening ring at each of the first end and second end; and
a holding string disposed at a center portion of the elongated shaft,
wherein the tightening ring is configured to threadedly engage with the first end and the second end to secure a chalk at each end.

2. The chalk holding apparatus of claim 1, wherein a plurality of slits are formed on an outer surface of the elongated shaft to increase the comfortability for the user to hold the chalk holding apparatus.

3. The chalk holding apparatus of claim 1, wherein the holding string forms a string ring to enable the user's hand to go through so the user can hold the chalk holding apparatus while the string ring is located at the user's wrist.
